(19) United States
(12) Patent Application Publication
(10) Pub. No.: US 2022/0260104 A1
(43) Pub. Date: Aug. 18, 2022

(54) VEHICLE ENGINE CARBON FIBER HEAD BOLT

(71) Applicant: Prototype Investments, LLC, Wilmington, NC (US)

(72) Inventor: Paul Kendra, Wilmington, NC (US)

(21) Appl. No.: 17/592,823

(22) Filed: Feb. 4, 2022

Related U.S. Application Data
(60) Provisional application No. 63/150,284, filed on Feb. 17, 2021.

(51) Int. Cl. F16B 33/00; F16B 25/00; F02F 1/24

(52) U.S. Cl. CPC F16B 33/006; F02F 1/24; F16B 25/0073; F16B 25/0063

(57) ABSTRACT

The presently disclosed subject matter generally relates to vehicle fastening systems that include head bolts. The disclosed head bolts are adapted to be used in internal combustion engines in a wide variety of vehicles. Specifically, the disclosed head bolts are used to fasten an engine's cylinder head to the engine block housing the pistons. Advantageously, the disclosed head bolt is constructed from carbon fiber material, providing several advantages over prior art fasteners. For example, the head bolt is lightweight, temperature resistant, and exhibits increased strength when compared to conventional head bolts constructed from steel and other metals.

### CROSS-REFERENCE TO RELATED APPLICATIONS

This application claims priority to U.S. Provisional Patent Application No. 63/150,284, filed Feb. 17, 2021, the entire content of which is hereby incorporated by reference.

### TECHNICAL FIELD

The presently disclosed subject matter is directed to a vehicle engine carbon fiber head bolt, and to methods of making and using the disclosed head bolt.

### BACKGROUND

In the automotive industry, a wide variety of fastening devices are used to attach two or more components together. For example, steel head bolts are conventionally used in the cylinder head-engine block fastener interface of internal combustion engines. However, prior art head bolts suffer from several drawbacks. Particularly, steel head studs have a relatively low tensile strength. As a result, the head bolts are often a main point of failure, lifting the head and causing the engine head gaskets to fail. In addition, conventional metal head studs are heavy, adding weight to the engine. The additional weight can accumulate in high cylinder count engines, which can be detrimental in high performance vehicles. Further, at the elevated temperatures experienced in vehicle engines, conventional head bolts often fail, which can be both expensive and time consuming to fix and replace. It would therefore be beneficial to provide a vehicle head bolt that overcomes the shortcomings of the prior art, providing advantages to the life of the bolt, as well as performance advantages.

### SUMMARY

In some embodiments, the presently disclosed subject matter is directed to a vehicle head bolt configured to join an engine cylinder head to an engine block piston housing. Particularly, the head bolt comprises a first threaded section positioned adjacent to a first end of the head bolt, and a second threaded section positioned adjacent to a second end of the head bolt. The head bolt also includes a midsection positioned between the first and second sections of the head bolt. Advantageously, the head bolt comprises carbon fiber material.

In some embodiments, the threads of the first section, second section, or both comprise about 4-80 threads per inch.

In some embodiments, the threads of the first section, second section, or both comprise a major diameter of about 0.60-4 inches.

In some embodiments, the threads of the first section, second section, or both comprise a pitch of about 0.31-6.35 mm.

In some embodiments, the head bolt comprises about 100 weight percent carbon fiber, based on the total weight of the head bolt.

In some embodiments, the head bolt comprises about 25-99.9 weight percent carbon fiber material, based on the total weight of the head bolt.

In some embodiments, the first section, second section, midsection, or combinations thereof have a length of about 0.75-2.5 inches.

In some embodiments, the head bolt comprises a density of about 1-2 g/cm³.

In some embodiments, the head bolt comprises a tensile strength of about 300-700 KSI.

In some embodiments, at least one of the first section, midsection, and second section comprises about 100 weight percent carbon fiber and the remaining sections comprise a metal.

In some embodiments, the first and second sections comprise about 100 weight percent carbon fiber and the midsection comprises about 100 weight percent metal.

In some embodiments, the head bolt comprises a temperature resistance up to about 195-276° F.

In some embodiments, the presently disclosed subject matter is directed to a vehicle engine comprising one or more of the disclosed head bolts.

In some embodiments, the vehicle is selected from a car, truck, motorcycle, bus, train, boat, ship, or aircraft.

In some embodiments, the presently disclosed subject matter is directed to a method of joining a vehicle engine cylinder head to the vehicle engine piston block. Particularly, the method comprises positioning the first end of the disclosed head bolt into the threaded aperture of the engine block. The method includes passing an aperture of the engine cylinder head through the second threaded section of the head bolt, such that the midsection of the head bolt is between the engine block and the cylinder head. The method further includes affixing washers and nuts over the second end of the head bolt to secure the vehicle engine cylinder head to the vehicle engine piston block.

In some embodiments, the method includes repeating the process a desired number of times with a desired number of head bolts.

In some embodiments, the presently disclosed subject matter is directed to a kit. Particularly, the kit includes a plurality of the disclosed vehicle head bolts, a plurality of head bolt nuts, and a plurality of head bolt washers.

### BRIEF DESCRIPTION OF THE DRAWINGS

The previous summary and the following detailed descriptions are to be read in view of the drawings, which illustrate some (but not all) embodiments of the presently disclosed subject matter.

FIG. 1 is a perspective view of a vehicle head bolt in accordance with some embodiment of the presently disclosed subject matter.

FIG. 2a is a fragmentary cross-sectional view of a vehicle head bolt threading in accordance with some embodiment of the presently disclosed subject matter.

FIG. 2b is a fragmentary cross-sectional view of two vehicle head bolt threads in accordance with some embodiment of the presently disclosed subject matter.

FIG. 2c is a fragmentary view of a vehicle head bolt in accordance with some embodiment of the presently disclosed subject matter.

FIG. 3a is a side plan view of a vehicle head bolt in accordance with some embodiment of the presently disclosed subject matter.

FIG. 3b is a cross-sectional view of a vehicle head bolt in accordance with some embodiment of the presently disclosed subject matter.

FIG. 4 is a perspective view of a vehicle engine block in accordance with some embodiment of the presently disclosed subject matter.

FIG. 5a is a cross-sectional view of an engine block aperture in accordance with some embodiment of the presently disclosed subject matter.

FIG. 5b is a cross-sectional view of an engine block aperture comprising a bushing in accordance with some embodiment of the presently disclosed subject matter.

FIG. 5c is a cross-sectional view of a vehicle head bolt configured in an engine block aperture in accordance with some embodiment of the presently disclosed subject matter.

FIG. 6 is an exploded perspective view of a vehicle block, vehicle head bolts, and an engine cylinder head.

FIG. 7 is an exploded view of various kit components in accordance with some embodiment of the presently disclosed subject matter.

### DETAILED DESCRIPTION

The presently disclosed subject matter is introduced with sufficient details to provide an understanding of one or more particular embodiments of broader inventive subject matters. The descriptions expound upon and exemplify features of those embodiments without limiting the inventive subject matters to the explicitly described embodiments and features. Considerations in view of these descriptions will likely give rise to additional and similar embodiments and features without departing from the scope of the presently disclosed subject matter.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a device” can include a plurality of such devices, and so forth.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/−0.1-20% from the specified amount, as such variations are appropriate in the disclosed packages and methods.

The presently disclosed subject matter can be implemented in several different forms. However, the present disclosure of such embodiments is to be considered an example of the principles and are not intended to limit the invention to the specific embodiments shown and described. Like reference numerals are used to describe the same, similar, or corresponding part in the several views of the drawings. The detailed description defines terms used herein and specifically describes embodiments for those skilled in the art to practice the presently disclosed subject matter.

The presently disclosed subject matter generally relates to vehicle fastening systems that include head bolts. The disclosed head bolts are adapted to be used in internal combustion engines in a wide variety of vehicles. The term “head bolt” refers to any attachment mechanism that can be used to fasten an engine's cylinder head to the engine block housing the pistons. Advantageously, the disclosed head bolt is constructed from carbon fiber material, providing several advantages over prior art fasteners. For example, the head bolt is lightweight and exhibits increased strength when compared to conventional head bolts, as discussed in detail below.

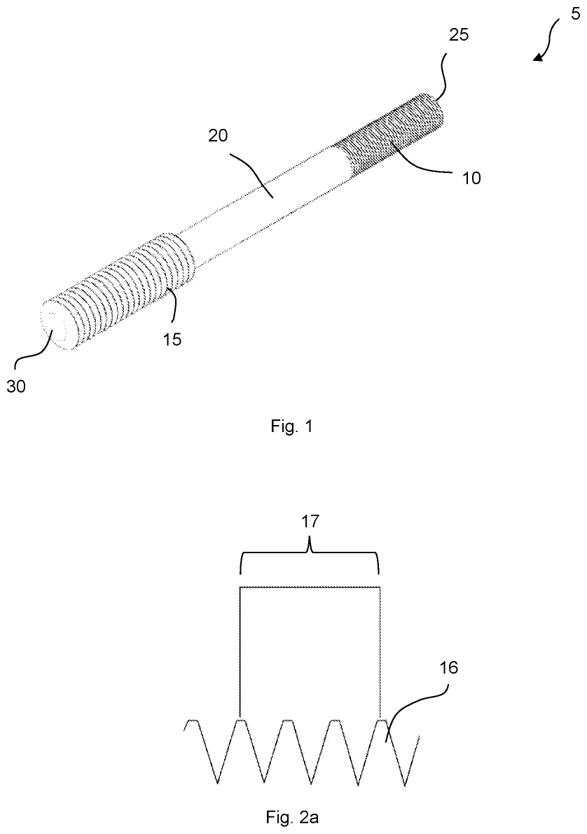

FIG. 1 illustrates one embodiment of head bolt 5. As shown, the head bolt includes first section 10 positioned adjacent to bolt first end 25, and second section 15 positioned adjacent to bolt second end 30. The bolt further includes midsection 20 positioned between the first and second sections.

As illustrated, both the first and second sections of the disclosed head bolt are threaded. The term “threaded” refers to the characteristic of having a helical or spiral ridge. The first and second head bolt sections can include any thread type, such as (but not limited to) UNC threads (Unified National Coarse Threads) and/or UNF Threads (Unified National Fine Threads). Suitable UNC threads can range from about 4-64 threads per inch, with a major diameter of about 0.73-4 inches and a pitch of about 0.397 to 6.35 mm, as shown below in Table 1:

TABLE 1
Unified Course Threads

| Major Diameter | Threads per | Major Diameter | |
|---|---|---|---|
| (in) | inch (tpi) | (mm) | Pitch (mm) |
| #1-64 | 64 | 1.854 | 0.397 |
| #2-56 | 56 | 2.184 | 0.453 |
| #3-48 | 48 | 2.515 | 0.529 |
| #4-40 | 40 | 2.845 | 0.635 |
| #5-40 | 40 | 3.175 | 0.635 |
| #6-32 | 32 | 3.505 | 0.794 |
| #8-32 | 32 | 4.166 | 0.494 |
| #10-24 | 24 | 4.826 | 1.058 |
| #12-24 | 24 | 5.486 | 1.058 |
| ¼″-20 | 20 | 6.350 | 1.270 |
| 5/16″-18 | 18 | 7.938 | 1.411 |
| ⅜″-16 | 16 | 9.525 | 1.587 |
| 7/16″-14 | 14 | 11.112 | 1.814 |
| ½″-13 | 13 | 12.7 | 1.954 |
| 9/16″-12 | 12 | 14.288 | 2.117 |
| ⅝″-11 | 11 | 15.875 | 2.309 |
| ¾″-10 | 10 | 19.050 | 2.540 |
| ⅞″-9 | 9 | 22.225 | 2.822 |
| 1″-8 | 8 | 25.4 | 3.175 |
| 1⅛″-7 | 7 | 28.575 | 3.628 |
| 1¼″-7 | 7 | 31.75 | 3.628 |
| 1⅜″-6 | 6 | 34.925 | 4.233 |
| 1½″-6 | 6 | 38.1 | 4.233 |
| 1¾″-5 | 5 | 44.45 | 5.080 |
| 2″-4½ | 4.5 | 5.08 | 5.644 |
| 2¼″-4½ | 4.5 | 5744.15 | 5.644 |
| 2½″-4 | 4 | 63.5 | 6.350 |
| 2¾″-4 | 4 | 69.85 | 6.350 |
| 3″-4 | 4 | 7602 | 6.350 |
| 3¼″-4 | 4 | 82.55 | 6.350 |
| 3½″-4 | 4 | 88.9 | 6.350 |
| 3¾″-4 | 4 | 95.25 | 6.350 |
| 4″-4 | 4 | 101.6 | 6.350 |

Suitable UNF threads can range from about 12-80 threads per inch, with a major diameter of about 0.60-1.5 inches and a pitch of about 0.317-2.117 mm, as shown below in Table 2:

TABLE 2
Unified National Fine Threads

| | | Major | |
|---|---|---|---|
| Major | Threads per | Diameter | |
| Diameter (in) | inch (tpi) | (mm) | Pitch (mm) |
| 0-80 | 80 | 1.524 | 0.317 |
| #1-72 | 72 | 1.854 | 0.353 |
| #2-64 | 64 | 2.184 | 0.397 |
| #3-56 | 56 | 2.515 | 0.453 |
| #4-48 | 48 | 2.845 | 0.529* |
| #5-44 | 44 | 3.175 | 0.577 |
| #6-40 | 40 | 3.505 | 0.635 |
| #8-36 | 36 | 4.166 | 0.705 |
| #10-32 | 32 | 4.826 | 0.794 |
| #12-28 | 28 | 5.486 | 0.907 |
| ¼″-28 | 28 | 6.350 | 0.907 |
| 5/16″-24 | 24 | 7.938 | 1.058 |
| ⅜″-24 | 24 | 9.525 | 1.058 |
| 7/16″-20 | 20 | 11.112 | 1.270 |
| ½″-20 | 20 | 12.7 | 1.270 |
| 9/16″-18 | 18 | 14.288 | 1.411 |
| ⅝″-18 | 18 | 15.875 | 1.411 |
| ¾″-16 | 16 | 19.050 | 1.587 |
| ⅞″-4 | 14 | 22.225 | 1.814 |
| 1″-12 | 12 | 25.4 | 2.117 |
| 1⅛″-12 | 12 | 28.575 | 2.117 |
| 1¼″-12 | 12 | 31.75 | 2.117 |
| 1⅜″-12 | 12 | 34.925 | 2.117 |
| 1½″-12 | 12 | 38.1 | 2.117 |

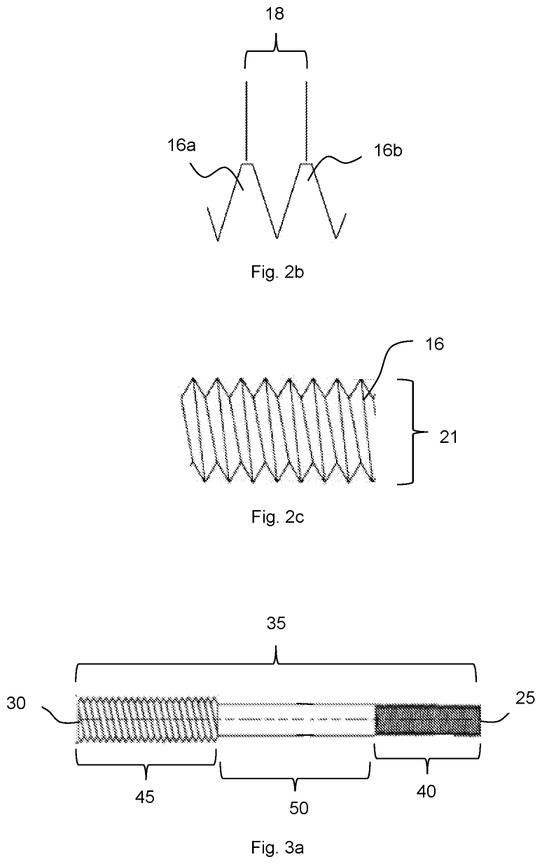

In some embodiments, first and second sections 10, 15 can have about the same threading with respect to major diameter, threads per inch, and pitch. Alternatively, the threading of the first section can differ from the threading of the second section in major diameter, threads per inch, and/or pitch. As shown in FIG. 2a, the “threads per inch” refers to the number of threads 16 (number of screw threads) per inch 17. The term “pitch” refers to the distance 18 between turns of two adjacent screw threads 16a and 16b, as shown in FIG. 2b. A screw thread “major diameter” refers to the diameter 21 at the crest of thread 16, as illustrated in FIG. 2c.

When the threading of first and second sections 10, 15 differ, the difference in major diameter, threads per inch, and/or pitch can be about 0.01-50%. Thus, the major diameter, threads per inch, and/or pitch of first section 10 can be greater or less than the major diameter, threads per inch, and/or pitch of second section 15 by about 0.01-50% (e.g., at least/no more than about 0.01, 0.1, 0.5, 1, 5, 10, 15, 20, 25, 30, 35, 40, 45, or 50 percent).

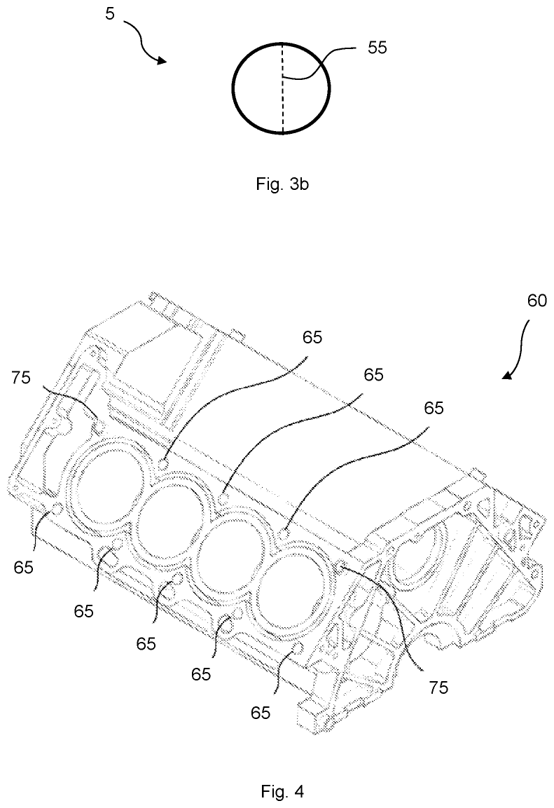

As shown in FIG. 3a, bolt 5 includes total length 35. The term “length” refers to the longest horizontal distance of the bolt. For example, total length 35 refers to the horizontal distance between first end 25 and second end 30. In some embodiments, the total length 35 of the bolt can be about 4-8 inches (e.g., at least/no more than about 4, 4.25, 4.5, 4.75, 5, 5.25, 5.5, 5.75, 6, 6.25, 6.5, 6.75, 7, 7.25, 7.5, 7.75, or 8 inches).

The head bolt first and second sections 10, 15 can have any suitable length, such as about 0.75-2.5 inches. Thus, first section length 40 and/or second section length 45 can be at least about/no more than about 0.75, 1, 1.25, 1.5, 1.75, 2, 2.25, or 2.5 inches. In some embodiments, the length of the first section can be about the same as the length of the second section. In other embodiments, first section length 40 can differ from the second section length 45 by about +/−0.01-50 percent (e.g., at least/no more than about 0.01, 0.1, 0.5, 1, 5, 10, 15, 20, 25, 30, 35, 40, 45, or 50 percent).

Midsection 20 can have any suitable length, such as about 1-4 inches. Thus, the head bolt can include midsection length 50 of at least/no more than about 1, 1.25, 1.5, 1.75, 2, 2.25, 2.5, 2.75, 3, 3.25, 3.5, 3.75, or 4 inches.

Head bolt 5 further includes diameter 55 of about 0.25-1 inches (e.g., at least/no more than about 0.25, 0.3, 0.35, 0.4, 0.45, 0.5, 0.55, 0.6, 0.65, 0.7, 0.75, 0.8, 0.85, 0.9, 0.95, or 1 inches). The term “diameter” refers to the longest straight-line segment that passes through the center of an element and whose endpoints are on the outer perimeter of the element, as shown in FIG. 3b. In some embodiments, one or more of first section 10, second section 15, and midsection 20 can have about the same diameter as least one other section. In other embodiments, each section of the head bolt is larger or smaller than at least one of the other two sections.

It should be appreciated that disclosed head bolt 5 is not limited and can have a lengths and diameter greater or less than the ranges given above.

The bolt can have any desired cross-sectional shape, such as (but not limited to) rounded or oval.

Head bolt 5 can be constructed from any suitable material, such as (but not limited to) carbon fiber. The term “carbon fiber” refers to material comprising thin fibers (e.g., about 0.005-0.01 mm in diameter) of carbon atoms. The carbon atoms can be bonded together in microscopic crystals that are aligned in a generally parallel manner with respect to the long axis of the fiber. In some embodiments, the carbon fiber can include at least about 70, 75, 80, 85, 90, 95, or 100 weight percent carbon, based on the total weight of the fiber. Without being bound by any theory, the crystal alignment is believed to confer strength to the carbon fiber. Several thousand carbon fibers can be twisted together to form a yarn, which can be used by itself or woven into a fabric. Carbon fiber has many different weave patterns and can be combined with a plastic resin and wound or molded to form composite materials such as carbon fiber reinforced plastic (also referred as “carbon fiber”) to provide a high strength-to-weight ratio material.

In some embodiments, head bolt 5 can include about 100 weight percent carbon fiber material (e.g., the first section, second section, and midsection each comprise about 100 weight percent carbon fiber). In other embodiments, the carbon fiber material is blended with one or more additional materials (e.g., plastics such as polyethylene, polypropylene, nylon, polyolefins, rubber, polyurethane, polyethylene terephthalate, or combinations thereof). Thus, at least one section of the disclosed head bolt can comprise about 25-100 weight percent carbon fiber (e.g., at least/no more than about 25, 30, 35, 40, 45, 50, 55, 60, 65, 70, 75, 80, 85, 90, 95, or 100 weight percent) and about 0-75 weight percent filler(s) (e.g., at least/no more than about 0, 1, 2, 3, 4, 5, 10, 15, 20, 25, 30, 35, 40, 45, 50, 55, 60, 65, 70 weight percent). The term “filler” can include any material that does adversely react with carbon fiber when blended therewith. Suitable fillers can include (but are not limited to) talc, mica, clay, calcium hydroxide, hydrotalcite, silica, metal oxides, calcium carbonate, titanium oxide, titanium dioxide, alumina, kaolin, zinc sulphide, ferrite, glass powder, zinc oxide, nickel carbonate, or combinations thereof. In other embodiments, the filler can include one or more metals, such as steel, stainless steel, aluminium, copper, and the like. The term “metal” includes any electropositive chemical element (e.g., alkali metal, alkaline earth metal, transition metal, basic metal).

In some embodiments, only a portion of the head bolt comprises carbon fiber. For example, at least one of the first section, second section, and midsection comprises carbon fiber, while the remaining section(s) comprise steel, stainless steel, or one or more metals. Thus, the middle section can comprise steel, stainless steel or a metal, while the first and second sections comprise carbon fiber. The inverse can also be true, where the midsection comprises carbon fiber material and the first and second sections comprise steel, stainless steel, or one or more metals. Alternatively, the middle section and one of the first or second sections can include carbon fiber, while the remaining first or second section can include stainless steel, steel, or metal(s). It is believed that a combination of carbon fiber and metal or steel/stainless steel can provide the head bolt with the desirable qualities of the carbon fiber yet provide added weight and heft to the bolt to prevent damage, movement, and the like during use.

Due at least in part to the carbon materials, head bolt 5 comprises a lightweight characteristic compared to conventional metal head bolts. The term “lightweight” refers to a weight that is at least about 5-99.99% less than the weight of a corresponding head bolt constructed from steel or another metal. Thus, the carbon fiber head bolt can have a weight that is at least about (or no more than about) 5, 10, 15, 20, 25, 30, 35, 40, 45, 50, 55, 60, 65, 70, 75, 80, 85, 90, 95, 99, or 99.99 percent less than conventional head bolts. For example, the disclosed head bolt can have a density of about 1-2 g/cm³, although the density can be greater or less than the disclosed range.

In addition, the disclosed head bolt comprises an increased tensile strength compared to conventional (e.g., steel) head bolts. The term “tensile strength” refers to the maximum stress a material can withstand while being stretched or pulled by an applied load. In some embodiments, the tensile strength of head bolt 5 can be about 500 KSI. Thus, the tensile strength of the disclosed head bolt can range from about 300-700 KSI (e.g., at least/no more than about 300, 325, 350, 375, 400, 425, 450, 475, 500, 525, 550, 575, 600, 625, 650, 675, or 700 KSI).

Due at least in part to the carbon fiber materials, head bolt 5 can withstand the stresses associated with the specified predetermined fastener torque in the range of engine operating temperatures (e.g., about 195-276° F.).

In some embodiments, head bolt 5 can be constructed as a single piece using machining, casting, thermoforming, and other methods known in the art. Alternatively, one or more elements of the head bolt (e.g., sections 10, 15, 20) can be releasably or permanently joined together using welding, adhesives, and the like.

The disclosed head bolt can be used at the cylinder head-engine block interface in a wide variety of vehicles. The term “vehicle” refers to a device for transporting animate and/or inanimate objects (e.g., persons and/or things), such as a self-propelled conveyance. Typical vehicles can include (but are not limited to) various makes and models of cars, trucks, motorcycles, buses, automobiles, trains, railed conveyances, boats, ships, marine conveyances, submarine conveyances, aircraft, space craft, and the like.

In use, head stud 5 joins an engine cylinder head to the engine's piston block. FIG. 4 illustrates one embodiment of a representative engine block 60 comprising one or more apertures 65 positioned on each side of the engine block. The term “engine block” broadly refers to a solid structure in which at least one cylinder of an engine is provided. In some embodiments, one or more apertures can include alignment bushings 75 designed to snugly mate with corresponding mating-alignment features located on the cylinder head to enabling fastening, as described below. The primary function of apertures 65 is to fasten the cylinder head to engine block 60 once alignment has been achieved. It should be appreciated that the engine block can include any number of apertures with or without alignment bushings, depending on user preference and the specifications of the vehicle engine.

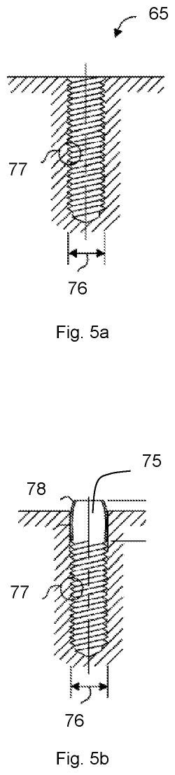

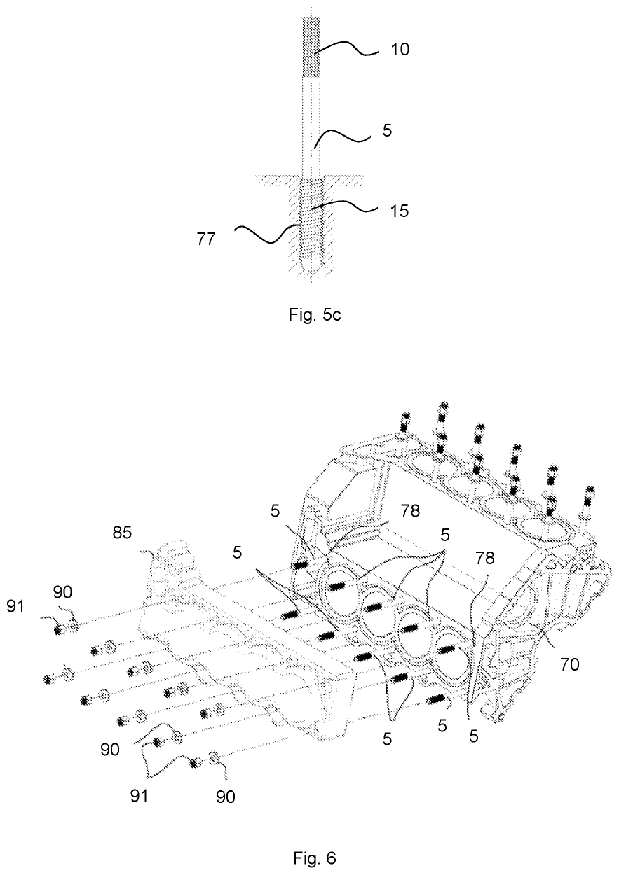

FIG. 5a illustrates one embodiment of aperture 65 comprising diameter 76 and internal threads 77. The threads can have any suitable configurations and dimensions. It should be appreciated that aperture threading 77 is configured to accommodate the corresponding head bolt threads of first or second section 10, 15.

FIG. 5b illustrates one embodiment of aperture 65 comprising alignment bushing 75. The term “bushing” refers to a fastener element added into an object to create a threaded hole. Bushing 75 can be constructed from any desired material, including (but not limited to) metal, plastic, carbon fiber, and the like. The bushing is typically press-fit into aperture 65, although any mechanism can be used. The bushing includes protruding portion 78 that extends from the tapped hole, thereby providing an aligning function between the cylinder head and the engine block when joined.

Head bolt 5 can be inserted in aperture 65, as shown in FIG. 5c. Particularly, second section 15 is mated with aperture threads 77. The remainder of the head bolt extends from the engine block aperture, with the threading of first section 10 exposed. It should be appreciated that the head bolt can be designed such that first section 10 of the head bolt mates with the engine block aperture and the second section threading is exposed, depending on the vehicle make and model.

Engine cylinder head 85 can then be joined to the engine piston block, as shown in FIG. 6. Because one end of the head bolt has been attached to engine cylinder head, the exposed portion of each head bolt is passed through a corresponding aperture defined in the engine piston block. Fastening the cylinder head to the block can be accomplished by affixing washers 90 and cylinder head nuts 91 as would be known in the art. By doing so, the engine cylinder head and the engine piston block are connected together with the head bolt interposed therebetween.

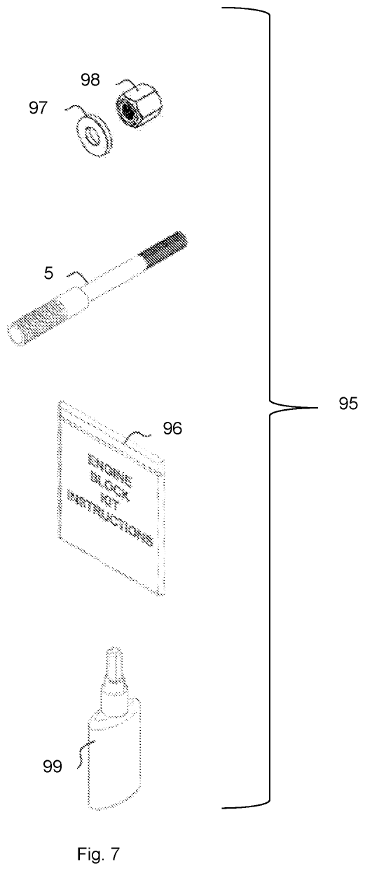

It should be appreciated that disclosed head bolt 5 can be used with new or retrofit engines. To this end, the head bolt can be provided as kit 95. One example of a head bolt kit is illustrated in FIG. 7. Particularly, kit 95 includes one or more head bolts 5, in additional to instructions 96 (which can include printed directions, CD-based directions, flash drive directions, webpage directions, etc.), head washers 97, head nuts 98, and/or thread locking fluid 99. It is understood that a variety of head bolt kits can be assembled having any combination of additional items or components useful to join an engine block to a cylinder head.

The disclosed head bolt offers many advantages over prior art devices. For example, head bolt 5 is reliable and possesses a long service life.

The disclosed head bolt also can be easily and quickly installed by a user.

Head bolt 5 exhibits increased tensile strength compared to conventional head bolts. As a result, the disclosed head bolt is more resilient and provides a longer lifespan before the need for replacement arises.

The disclosed head bolt can be used in high temperature environments, such as the conditions of engine use.

Head bolt 5 is also lightweight compared to conventional bolts constructed from steel, which can translate to performance advantages.

Although the presently disclosed subject matter has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A vehicle head bolt configured to join an engine cylinder head to an engine block piston housing, the head bolt comprising:
a first threaded section positioned adjacent to a first end of the head bolt;
a second threaded section positioned adjacent to a second end of the head bolt;
a midsection positioned between the first and second sections of the head bolt;
wherein the head bolt comprises carbon fiber material.

2. The head bolt of claim 1, wherein the threads of the first section, second section, or both comprise about 4-80 threads per inch.

3. The head bolt of claim 1, wherein the threads of the first section, second section, or both comprise a major diameter of about 0.60-4 inches.

4. The head bolt of claim 1, wherein the threads of the first section, second section, or both comprise a pitch of about 0.31-6.35 mm.

5. The head bolt of claim 1, wherein the head bolt comprises about 100 weight percent carbon fiber, based on the total weight of the head bolt.

6. The head bolt of claim 1, wherein the head bolt comprises about 25-99.9 weight percent carbon fiber material, based on the total weight of the head bolt.

7. The head bolt of claim 1, wherein at least one of the first section, midsection, and second section comprises about 100 weight percent carbon fiber and the remaining sections comprise steel, stainless steel, or metal.

8. The head bolt of claim 7, wherein the first and second sections comprise about 100 weight percent carbon fiber and the midsection comprises about 100 weight percent steel, stainless steel, or metal.

9. The head bolt of claim 1, comprising a density of about 1-2 g/cm³.

10. The head bolt of claim 1, comprising a tensile strength of about 300-700 KSI.

11. The head bolt of claim 1, comprising a temperature resistance up to about 195-276° F.

12. A vehicle engine comprising the head bolt of claim 1.

13. A method of joining a vehicle engine cylinder head to the vehicle engine piston block, the method comprising:
positioning the first end of a head bolt into the threaded aperture of the engine block, wherein the head bolt is defined by:
a first threaded section positioned adjacent to a first end of the head bolt;
a second threaded section positioned adjacent to a second end of the head bolt;
a midsection positioned between the first and second sections of the head bolt;
wherein the head bolt comprises carbon fiber material;
passing an aperture of the engine cylinder head through the second threaded section of the head bolt, such that the midsection of the head bolt is between the engine block and the cylinder head;
affixing washers and nuts over the second end of the head bolt to secure the vehicle engine cylinder head to the vehicle engine piston block.

14. The method of claim 13, wherein the head bolt comprises about 100 weight percent carbon fiber, based on the total weight of the head bolt.

15. The method of claim 13, wherein the head bolt comprises about 25-99.9 weight percent carbon fiber material, based on the total weight of the head bolt.

16. The method of claim 13, wherein the vehicle is selected from a car, truck, motorcycle, bus, train, boat, ship, or aircraft.

17. The method of claim 13, further comprising repeating the process a desired number of times.

18. A kit comprising:
a plurality of vehicle head bolts, wherein each head bolt is defined by:
a first threaded section positioned adjacent to a first end of the head bolt;
a second threaded section positioned adjacent to a second end of the head bolt;
a midsection positioned between the first and second sections of the head bolt;
wherein the head bolt comprises carbon fiber material;
a plurality of head bolt nuts; and
a plurality of head bolt washers.

19. The kit of claim 18, wherein each head bolt comprises about 100 weight percent carbon fiber, based on the total weight of the head bolt.

20. The kit of claim 18, wherein each head bolt comprises about 25-99.9 weight percent carbon fiber material, based on the total weight of the head bolt.
